(19) United States
(12) Patent Application Publication
(10) Pub. No.: US 2006/0020721 A1
(43) Pub. Date: Jan. 26, 2006

(54) Configurable ping-pong buffers for USB buffer descriptor tables

(75) Inventors: Igor Wojewoda, Tempe, AZ (US); Ross Fosler, Casa Grande, AZ (US); Rawin Rojvanit, Chandler, AZ (US)

Correspondence Address: BAKER BOTTS, LLP, 910 LOUISIANA, HOUSTON, TX, 77002-4995, US

(73) Assignee: Microchip Technology Incorporated

(21) Appl. No.: 11/075,149

(22) Filed: Mar. 8, 2005

Related U.S. Application Data
(60) Provisional application No. 60/574,563, filed on May 26, 2004.

(51) Int. Cl. G06F 3/06

(52) U.S. Cl. 710/52

(57) ABSTRACT

A digital device having selectable modes for USB communications buffer management in a USB interface of the digital device. These modes may comprise (1) no ping-pong buffer support, (2) ping-pong buffer support for some endpoints, e.g., support for OUT endpoint 0 only, and (3) ping-pong buffer support for all endpoints. In the no ping-pong buffer support mode, no hardware is required for automatic ping-pong buffer management. The Buffer Descriptor Tables may comprise a maximum of 128 memory locations, e.g., 16 IN endpoints and 16 OUT endpoints, each with at least one buffer descriptor, and each comprising four (4) memory locations. In the ping-pong buffer support for OUT endpoint 0 only mode, the buffer descriptor Tables may comprise a maximum of 132 memory locations, e.g., 16 OUT endpoints with an EVEN and an ODD endpoint 0, 16 IN endpoints, each with at least one descriptor, e.g., memory locations. This mode assures that endpoint 0 setup transfers may be serviced without delay while only requiring a minimal number of memory locations for the remainder of the buffer descriptors. In the ping-pong buffer support for all endpoints mode, automatic ping-pong buffer management may be provided for all endpoints. The Buffer Descriptor Tables may comprise a maximum of 256 memory locations, e.g., 16 IN endpoints and 16 OUT endpoints, an EVEN and ODD set for each, each with one descriptor, e.g., four (4) memory locations. This mode assures that all endpoint transfers may be serviced substantially without delay.

### RELATED PATENT APPLICATION

This application claims priority to commonly owned U.S. Provisional Patent Application Ser. No. 60/574,563; filed May 26, 2004; which is hereby incorporated by reference herein for all purposes.

### TECHNICAL FIELD OF THE INVENTION

The present disclosure relates to digital devices, more particularly, to more efficient handling of USB information transactions with a digital device.

### BACKGROUND OF THE RELATED TECHNOLOGY

A digital device having a typical serial communications interface such as a Universal Synchronous/Asynchronous Receiver Transmitter (USART) is limited to only two data streams, input and output. In most cases, these two data streams share the same buffer space. In contrast, a digital device having a Universal Serial Bus (USB) interface allows many data streams, each of which can have a well defined behavior, e.g., a unique data consumer and producer. Although a USB device on a USB network has a single and unique address, more granular locations may be defined within that address space. Source and destination information between a USB host and USB device are called “endpoints.”

A ping-pong buffer is used with a digital processor and a USB interface wherein an endpoint is defined to have two sets of buffer descriptors; one set for an EVEN transfer and one set for an ODD transfer. This allows the digital processor to process one endpoint while the USB interface is processing the other endpoint. Double buffering of endpoints in this way allows efficient transfer of data at the maximum throughput available with the USB interface.

Endpoint buffer descriptors take up valuable register and memory space, thus, requiring valuable device resources be dedicated to the USB interface. In the design of a digital device having an embedded USB interface, a balance must be made between cost and performance, thus, either a full set of “ping-pong” buffers or no ping-pong buffers have been implemented.

Therefore, there is a need for a digital device having a USB interface that is more flexible in configuration so that USB communications may be more easily optimized for a desired application.

### SUMMARY OF THE INVENTION

The present invention overcomes the above-identified problems as well as other shortcomings and deficiencies of existing technologies by providing an apparatus, system and method for selecting different modes for USB communications buffer management in a USB interface of a digital device. These modes may comprise (1) no ping-pong buffer support, (2) ping-pong buffer support for some endpoints, e.g., support for OUT endpoint 0 only, and (3) ping-pong buffer support for all endpoints. There may be up to 16 IN endpoints and up to 16 OUT endpoints. Each of the IN and OUT endpoints has at least one buffer descriptor. Each buffer descriptor is stored in at least one memory location. The ping-pong buffer has at least a single EVEN endpoint and a single ODD endpoint (each endpoint having its own buffer descriptor). It is contemplated and within the scope of the invention that the ping-pong buffer may have a plurality of EVEN endpoints and a plurality of ODD endpoints (each endpoint having its own buffer descriptor). Each buffer descriptor may use, for example, four (4) memory bytes locations but this is not a requirement nor should it be considered a limitation.

For example, but without limiting the invention: Specifically (assuming 4 bytes per endpoint), (a) having 16 IN endpoints and 16 OUT endpoints requires (16+16)×4=128 memory locations, (b) having 16 IN endpoints, 16 OUT endpoints, and an EVEN/ODD endpoint on OUT endpoint 0 requires (16+15+2)×4 =132 memory locations, and (c) having EVEN/ODD 16 IN endpoints and EVEN/ODD 16 OUT endpoints requires (16×2+16×2)×4 =256 memory locations. Each endpoint, in addition to having a buffer descriptor, may also have a dedicated memory buffer (having the ability to add or subtract buffers goes hand in hand with the buffer descriptors). Each memory buffer has one or more memory locations (typically many more, and hence additional savings and flexibility).

It is contemplated and within the scope of the invention that the number of EVEN/ODD endpoints is fully configurable (e.g., EP0 through EP7 may be EVEN/ODD, but the rest may have only a single buffer descriptor). Also, it is contemplated and within the scope of the invention that there may be more than just EVEN/ODD endpoints, e.g., each of the endpoints may have multiple buffer descriptors, so that there may be from 1 to n number of buffer descriptors per endpoint (wherein each buffer descriptor may be configurable).

According to a specific embodiment of the invention, in the no ping-pong buffer support mode, no hardware is required for automatic ping-pong buffer management. The Buffer Descriptor Tables may comprise a maximum of 128 memory locations, e.g., 16 IN endpoints and 16 OUT endpoints, each with at least one buffer descriptor, e.g., four (4) buffer descriptors.

According to another specific embodiment of the invention, in the ping-pong buffer support for OUT endpoint 0 only mode, the Buffer Descriptor Tables may comprise a maximum of 132 memory locations, e.g., 16 OUT endpoints with an EVEN and an ODD endpoint 0, 16 IN endpoints, each with at least one descriptor, e.g., four (4) descriptors. This mode substantially assures that endpoint 0 setup transfers may be serviced without delay while only requiring a minimal number of memory locations for the remainder of the descriptors.

According to yet another specific embodiment of the invention, in the ping-pong buffer support for all endpoints mode, automatic ping-pong buffer management may be provided for all endpoints. The Buffer Descriptor Tables may comprise a maximum of 256 memory locations, e.g., 16 IN endpoints and 16 OUT endpoints, an EVEN and ODD set for each, each with at least one descriptor, e.g., four (4) descriptors in each set. This mode assures that all endpoint transfers may be serviced substantially without delay.

According to a specific exemplary embodiment of the present invention, in a digital device where memory and CPU resources are limited, an optimal balance of cost versus performance may be determined without requiring an overly complex design. The present invention is adapted to spool multiple Endpoints between the time they can be serviced, and multiple Buffer Descriptors per Endpoint allow new transfers to commence without having to service the completed transfers.

A technical advantage of the invention is selection of a cost effective solution for handling USB transactions.

Another technical advantage is choosing to enable EVEN/ODD buffers (ping-pong buffer descriptors) for no endpoints, one endpoint (e.g., endpoint 0 OUT), or all endpoints.

Other technical advantages should be apparent to one of ordinary skill in the art in view of what has been disclosed herein.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a schematic block diagram of a digital device having a USB interface with selectable mode options for USB communications buffer management, according to a specific embodiment; and

FIG. 2 are memory maps for the different modes of EVEN/ODD ping-pong buffer descriptors, according to specific embodiments of the present invention;

While the present invention is susceptible to various modifications and alternative forms, specific exemplary embodiments thereof have been shown by way of example in the drawing and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Referring now to the drawings, the details of exemplary embodiments of the present invention are schematically illustrated. Like elements in the drawings will be represented by like numbers, and similar elements will be represented by like numbers with a different lower case letter suffix.

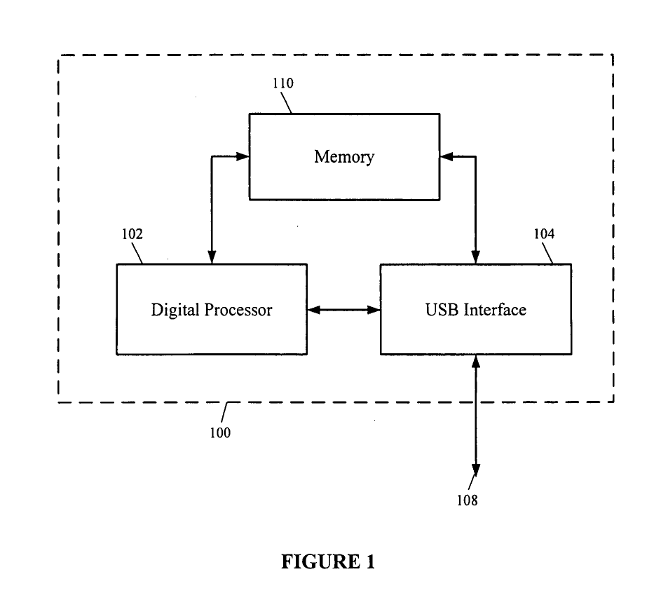

Referring to FIG. 1, depicted is a schematic block diagram of a digital device having a USB interface with selectable mode options for USB communications buffer management, according to a specific embodiment of the present invention. The digital device, generally represented by the numeral 100, comprises a digital processor 102, a USB interface 104, and a memory 110. The USB interface 104 has selectable mode options for USB communications buffer management, and produces USB signals on USB data lines 108 that conform to the USB specification. The memory 110 may comprise a random access memory (RAM) e.g., dual-port RAM and the like. The memory 110 is coupled to the digital processor 102 and USB interface 104 through, for example, separate ports, e.g., dual-port RAM. The digital processor 102 may be a microprocessor, microcontroller, digital signal processor (DSP), application specific integrated circuit (ASIC), programmable logic array (PLA), and the like.

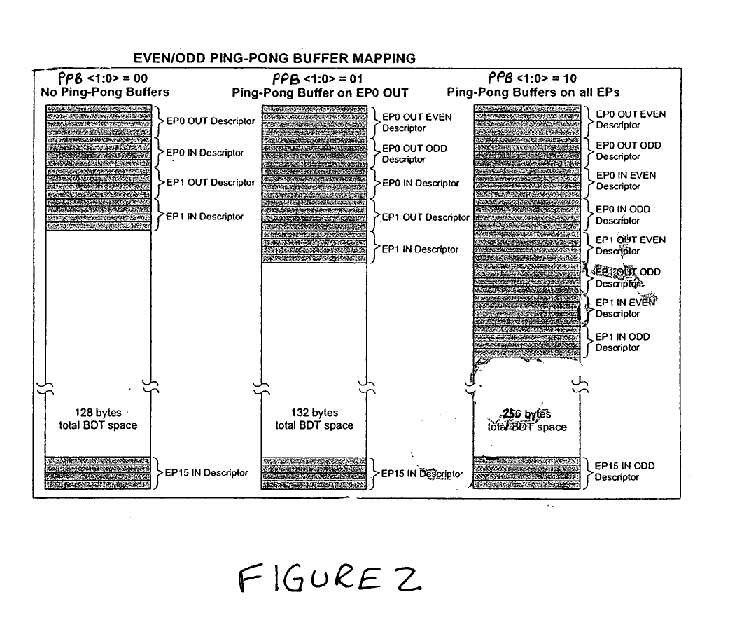

Referring to FIG. 2, depicted are memory maps for the different modes of EVEN/ODD ping-pong buffer descriptors, according to specific embodiments of the present invention. The digital device 100 may support three distinct modes for buffer management. These modes may comprise: (1) no ping-pong buffer support, (2) ping-pong buffer support for OUT endpoint 0 only, and (3) ping-pong buffer support for all endpoints. The ping-pong buffer mode settings may be configured using, for example, PPB<1:0> bits that may be located in a configuration register (not shown). FIG. 2 illustrates the various buffer descriptor locations for the various ping-pong buffer modes.

Ping-Pong Buffer Definition

An endpoint is defined to have a ping-pong buffer when it has two sets of buffer descriptor entries: one set for an EVEN transfer and one set for an ODD transfer. This allows the digital processor 102 to process one buffer descriptor while the USB interface 104 is processing the other buffer descriptor. Double buffering of the buffer descriptors, according to the present invention, allows the USB interface 104 to easily transfer data at the maximum throughput provided by the USB specification.

The USB interface 104 may keep track of a ping-pong pointer individually for each endpoint. All pointers are initially reset to the EVEN buffer descriptor. After the completion of a transaction, the pointer is toggled to the ODD buffer descriptor. After the completion of the next transaction, the pointer is toggled back to the EVEN buffer descriptor, and so on. Without the ping-pong buffer enabled, any endpoint references the same buffer descriptor value for each transaction.

No Ping-Pong Buffers Setting

When the PPB<1:0> bits are set to ‘00’, no hardware is required for automated ping-pong buffer management. The Buffer Descriptor Tables take up a maximum of 128 memory locations, e.g., 16 IN endpoints and 16 OUT endpoints, each with at least one buffer descriptor, e.g., four (4) buffer descriptors. The flexibility of the Buffer Descriptor Table allows this feature to be accomplish in software code. As an example, a transmit ping-pong buffer may be obtained by doing the following:
Define an IN endpoint (transmit buffer)
Write necessary Tx data to the buffer starting RAM location
Enable the endpoint
Write next data buffer to be transmitted to an unused RAM buffer
Wait for an interrupt which notifies that endpoint Tx is done
Reconfigure the buffer starting address location to point to the new buffer location
   A similar approach may be used to divert new, incoming endpoint data while old data is being processed.
   Ping-Pong on IN Endpoint 0 Only

When the PPB<1:0> bits are set to ‘01’, automated ping-pong buffer management may be provided for only the OUT Endpoint 0. The Buffer Descriptor Tables take up a maximum of 132 memory locations, e.g., 16 OUT endpoints with an EVEN and an ODD endpoint 0, 16 IN endpoints, each with at least one descriptor, e.g., four (4) descriptors. This mode assures that endpoint 0 setup transfers may be serviced without delay while requiring only a small amount of the memory 110 for the remainder of the buffer descriptors.

Ping-Pong on all Buffers

When the PPB<1 :0> bits are set to ‘10’, automated ping-pong buffer management may be provided for all Endpoints. The Buffer Descriptor Tables take up a maximum of 256 memory locations, e.g., 16 IN endpoints and 16 OUT endpoints, an EVEN and ODD set for each, each with at least one descriptor, e.g., four (4) descriptors in each set. This mode assures that all endpoint transfers may be serviced without delay.

It is contemplated and within the scope of the invention that the number of Even/Odd endpoints is fully configurable (e.g., EP0 through EP7 may be Even/Odd, but the rest may only have a single buffer descriptor). Also, it is contemplated and within the scope of the invention that there may be more than just Even/Odd endpoints, e.g., each of the endpoints may have multiple buffers, so that there is from 1 to n number of buffer descriptors per endpoint (each buffer descriptor being configurable). In addition, depending upon the word size, only one buffer descriptor per set may be necessary, e.g., a 32 bit word size.

The present invention has been described in terms of specific exemplary embodiments. In accordance with the present invention, the parameters for a device may be varied, typically with a design engineer specifying and selecting them for the desired application. Further, it is contemplated that other embodiments, which may be devised readily by persons of ordinary skill in the art based on the teachings set forth herein, may be within the scope of the invention, which is defined by the appended claims. The present invention may be modified and practiced in different but equivalent manners that will be apparent to those skilled in the art and having the benefit of the teachings set forth herein.

What is claimed is:

1. A digital device having a Universal Serial Bus (USB) interface, comprising:
a digital processor;
a USB interface coupled to the digital processor; and
a memory coupled to the digital processor and the USB interface, the memory adapted for providing USB communications buffers;
wherein the digital processor and the USB interface utilize the USB communications buffers such that a first mode has no ping-pong buffer support, a second mode has ping-pong buffer support for certain endpoints only, and a third mode has ping-pong buffer support for all endpoints.

2. The digital device according to claim 1, wherein the certain endpoints are an OUT endpoint 0.

3. The digital device according to claim 1, wherein the certain endpoints are a plurality of OUT endpoints.

4. The digital device according to claim 1, wherein the certain endpoints are a plurality of IN endpoints.

5. The digital device according to claim 1, wherein the certain endpoints are a plurality of IN endpoints and a plurality of OUT endpoints.

6. The digital device according to claim 1, wherein the first mode comprises at least one IN endpoint and at least one OUT endpoint, each of the at least one IN and at least one OUT endpoints has at least one buffer descriptor stored at least one memory location.

7. The digital device according to claim 6, wherein the at least one IN endpoint is 16 IN endpoints and the at least one OUT endpoint is 16 OUT endpoints, and each of the 16 IN endpoints and 16 OUT endpoints has at least one buffer descriptor.

8. The digital device according to claim 7, wherein each of the at least one buffer descriptors is comprised of four memory locations, whereby all of the at least one buffer descriptors use no more then 128 memory locations.

9. The digital device according to claim 1, wherein the ping pong buffers comprise at least one EVEN endpoint and at least one ODD endpoint, and each of the endpoints has at least one buffer descriptor.

10. The digital device according to claim 9, wherein the second mode comprises 16 OUT endpoints with an EVEN and an ODD endpoint 0, and 16 IN endpoints, each of the endpoints having at least one buffer descriptor.

11. The digital device according to claim 10, wherein each of the at least one buffer descriptors is comprised of four memory locations, whereby all of the at least one buffer descriptors use no more then 132 memory locations.

12. The digital device according to claim 9, wherein the third mode comprises 16 EVEN and 16 ODD OUT endpoints and 16 EVEN and 16 ODD IN endpoints, each of the endpoints having at least one buffer descriptor.

13. The digital device according to claim 12, wherein each of the at least one buffer descriptors is comprised of four buffer descriptors, whereby all of the at least one buffer descriptors use no more then 256 memory locations.

14. The digital device according to claim 1, wherein the memory comprises a random access memory.

15. The digital device according to claim 14, wherein the random access memory comprises a dual-port random access memory.

16. The digital device according to claim 1, wherein the digital processor is selected from the group consisting of a microprocessor, microcontroller, digital signal processor (DSP), application specific integrated circuit (ASIC) and programmable logic array (PLA).

17. The digital device according to claim 1, wherein the first, second and third modes are selected through unique bit patterns in a configuration register.

18. A method for selecting different modes for Universal Serial Bus (USB) communications buffer management, said method comprising the steps of:
providing a digital processor;
providing a USB interface coupled to the digital processor; and
providing a memory coupled to the digital processor and the USB interface, the memory adapted for providing USB communications buffers;
selecting a first, second or third mode for USB communications buffer management wherein when the first mode is selected there is no ping-pong buffer support, when the second mode is selected there is ping-pong buffer support for certain endpoints only, and when the third mode is selected there is ping-pong buffer support for all endpoints.

19. The method according to claim 18, wherein the step of selecting selects OUT endpoint 0.

20. The method according to claim 18, wherein the step of selecting selects a plurality of OUT endpoints.

21. The method according to claim 18, wherein the step of selecting selects a plurality of IN endpoints.

22. The method according to claim 18, wherein the step of selecting selects a plurality of IN endpoints and a plurality of OUT endpoints.

23. The method according to claim 18, wherein the step of selecting the first mode comprises the step of selecting at least one IN endpoint and at least one OUT endpoint, each of the at least one IN and at least one OUT endpoints has at least one buffer descriptor stored at least one memory location.

24. The method according to claim 23, wherein the at least one IN endpoint is 16 IN endpoints and the at least one OUT endpoint is 16 OUT endpoints, and each of the 16 IN endpoints and 16 OUT endpoints has at least one buffer descriptor.

25. The method according to claim 24, wherein each of the at least one buffer descriptors is comprised of four memory locations, whereby all of the at least one buffer descriptors use no more then 128 memory locations.

26. The method according to claim 18, wherein the ping pong buffers comprise at least one EVEN endpoint and at least one ODD endpoint, and each of the endpoints has at least one buffer descriptor.

27. The method according to claim 26, wherein the step of selecting the second mode comprises the step of selecting 16 OUT endpoints with an EVEN and an ODD endpoint 0, and 16 IN endpoints, each of the endpoints having at least one buffer descriptor.

28. The method according to claim 20, wherein each of the at least one buffer descriptors is comprised of four memory locations, whereby all of the at least one buffer descriptors use no more then 132 memory locations.

29. The method according to claim 26, wherein the step of selecting the third mode comprises the step of selecting 16 EVEN and 16 ODD OUT endpoints and 16 EVEN and 16 ODD IN endpoints, each of the endpoints having at least one buffer descriptor.

30. The method according to claim 29, wherein each of the at least one buffer descriptors is comprised of four buffer descriptors, whereby all of the at least one buffer descriptors use no more then 256 memory locations.

31. The method according to claim 18, wherein the memory comprises a random access memory.

32. The method according to claim 31, wherein the random access memory comprises a dual-port random access memory.

33. The method according to claim 18, wherein the digital processor is selected from the group consisting of a microprocessor, microcontroller, digital signal processor (DSP), application specific integrated circuit (ASIC) and programmable logic array (PLA).

34. The method according to claim 18, wherein the step of selecting the first, second or third modes comprises the step of selecting unique bit patterns in a configuration register.

35. The digital device according to claim 1, further comprising a dedicated memory buffer for each of the endpoints, wherein each dedicated memory buffer is comprised of at least one memory location.

36. The method according to claim 18, further comprising the step of providing a dedicated memory buffer for each of the endpoints, wherein each dedicated memory buffer is comprised of at least one memory location.
